(19) United States
(12) Patent Application Publication
(10) Pub. No.: US 2009/0076873 A1
(43) Pub. Date: Mar. 19, 2009

(54) Method and system to improve engineered system decisions and transfer risk

(75) Inventors: Christopher Donald Johnson, Clifton Park, NY (US); Brock Estel Osborn, Niskayuna, NY (US); Jens Alkemper, Schenectady, NY (US); Oladimeji Bassir, The Woodlands, TX (US); Onur Ilkin Dulgeroglu, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/901,992

(22) Filed: Sep. 19, 2007

(51) Int. Cl. G06Q 10/00

(52) U.S. Cl. 705/8

(57) ABSTRACT

A method and system are provided to improve industrial engineered systems such as oil well drilling decisions and transfer risk. The method and system each include an interactive decision-support planning tool that aids a user as to how to select a portfolio of engineered systems and entities that the systems will process such as aircraft engines and flights, rigs and reserves, apparatus configuration, apparatus inspection, apparatus on line sensors, dynamic operations decisioning for the apparatus and drill path or asset dispatching and a contractual incentive to allocate risks to stakeholders best positioned to abate them. The decision support will reduce a fleet's financial risk associated with the cost of operations below that achievable without using the interactive decision-support planning tool and/or increase financial return associated with the cost of activity above that achievable without using the interactive decision-support planning tool, such that the financial risk and/or financial return are allocated in a desired manner among a plurality of operations stakeholders.

### BACKGROUND

The invention relates generally to engineered system decisions and more particularly to an active decision support and contractual structure for effective asset utilization of industrial engineered systems such as engines, turbines and well drilling apparatus that aligns risks and enhances a fleet's risk and return ratio.

Asset utilization of oil and gas drilling apparatus, for example, is critical when the economic rents of drilling infrastructure can exceed $1 MM/day and capacity utilization is high. Effective asset utilization of drilling apparatus includes, among other things, 1) obtaining the right portfolio of drilling apparatus to drill the right holes for a given probabilistic reserve geometry and quantity, 2) avoiding equipment failures, 3) efficient configuration of a drill line, 4) efficient configuration of optional drill path(s), 5) providing drill rate decision support, and 6) providing a drilling capacity that includes guaranteed physical and financial performance for a fee.

It would be both advantageous and beneficial to provide a system and method that raises the mean productivity of fleet drilling apparatus by improving the likelihood of differentially more value creation than risk across the many discrete decisions in drilling selection, setup and operation, while also reducing the frequency of very costly field failures far down hole.

It would be further advantageous if the method and system were to challenge existing industry practice, offering improved risk and return from operations via an integrated decision support infrastructure aiding: well portfolio selection, drill rig portfolio selection, drill apparatus configuration, apparatus inspection, apparatus on line sensors, dynamic operations decisioning for the apparatus and drill path and a contractual incentive to allocate risks to stakeholders best positioned to abate them.

### BRIEF DESCRIPTION

Briefly, in accordance with one embodiment, a system to improve oil well drilling decisions and transferring financial risk is provided. The system comprises:

an interactive decision-support planning tool that aids a user as to how to drill the well and how to make drilling decisions while the well is being drilled; and

a plurality of sensors operational to generate data used by the interactive decision-support planning tool to reduce financial risk associated with the cost of drilling the well below that achievable without using the interactive decision-support planning tool and/or increase financial return associated with the cost of drilling the well above that achievable without using the interactive decision-support planning tool, such that the financial risk and/or financial return are allocated in a desired manner among a plurality of drilling operation stakeholders, wherein the stakeholders are held contracturally to subsets of a fleet of asset's risks.

According to another embodiment, a method of drilling a well comprises providing an interactive decision-support planning tool that aids a user as to how to drill the well and how to make drilling decisions while the well is being drilled to reduce financial risk associated with the cost of drilling the well below that achievable without using the interactive decision-support planning tool and/or increase financial return associated with the cost of drilling the well above that achievable without using the interactive decision-support planning tool, such that the financial risk and/or financial return are allocated in a desired manner among a plurality of drilling operation stakeholders, wherein the stakeholders are held contracturally to subsets of the fleet of asset's risks.

According to yet another embodiment, a method of operating an industrial engineered system comprises:

providing an interactive decision-support planning tool that aids a user as to how to operate an industrial engineered system and how to make system decisions while the system is operational; and

operating the interactive decision-support planning tool to generate operational decisions that reduce financial risk associated with the cost of operating the system below that achievable without using the interactive decision-support planning tool and/or increase financial return associated with the cost of operating the system above that achievable without using the interactive decision-support planning tool, such that the financial risk and/or financial return are allocated in a desired manner among a plurality of industrial engineered system operation stakeholders, wherein the stakeholders are held contracturally to subsets of a fleet of asset's risks.

### DRAWINGS

These and other features, aspects, and advantages of the present invention will become better understood when the following detailed description is read with reference to the accompanying drawings in which like characters represent like parts throughout the drawings, wherein:

FIG. 1 is a pictorial diagram illustrating decision factors and variables associated with an interactive decision-support planning tool according to one embodiment;

FIG. 2 is a pictorial diagram illustrating a plurality of decision-support well hole paths, according to one embodiment;

FIG. 3 is a graph illustrating a financial relationship between a plurality of decision factors, according to one embodiment;

FIG. 4 is a graph illustrating a technique to determine the value of a design feature associated with a physical system, according to one embodiment;

FIG. 5 is a graph illustrating another technique to determine the value of a design feature associated with a physical system, according to one embodiment;

FIG. 6 is a graph illustrating a system output value before and after addition of an option, according to one embodiment;

FIG. 7 is a histogram of costs related to different physical system investments, according to one embodiment;

FIG. 8 is a graph illustrating a technique for determining a physical system option value, according to one embodiment;

FIG. 9 is a block diagram illustrating an interactive decision-support planning tool according to one embodiment; and

FIG. 10 that illustrates a stochastic simulation process applied to power turbines.

While the above-identified drawing figures set forth alternative embodiments, other embodiments of the present invention are also contemplated for other industrial infrastructure, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION

Exemplary embodiments of a method and system to improve drilling decisions and transfer risk includes simulation techniques and physical inspection feedback data to optimize asset selection, configuration and operational support for a drilling rig at the point of decision are described herein with reference to the Figures.

An asset that includes in one embodiment, a drill string, geology and reserve, is configured that matches the reliability and performance of apparatus to an explicit drilling application so as to maximize the probability, in the context of a portfolio of drilling operations, specific assets to probabilistic reserves and paths to reserves.

A specific drill configuration is attained with an interactive simulation based design tool that explores all desired combinations of available and feasible drill platforms. The ‘virtual drill’ which is a model of the selected physical assets draws assumptions from a reliability and performance database that is then utilized to simulate a portfolio of drilling operations.

Four areas are enablers. These include: 1) sensor signals that are characterized with filtering and recognition algorithms to achieve monitoring without a human in the loop, 2) reliability and performance databases formulated with failure event observations data and the related remote monitoring and diagnostic sensor signals as described herein below, 3) Artificial Intelligence algorithms that mine these data to assess health and recognize temporal probability thresholds for failure or mission risk, and 4) simulation and optimization of the physical assets in a virtual operations mode that explores the feasible decision space against system objectives.

Upon simulating a configuration in a virtual drill mission, the financial risk/return is formulated with multiple (i.e. thousands) of simulation runs that sample from reliability and performance databases and explore feasible and most optimal configuration design space. The output is an interactive drilling asset model that is optimally configured for the uncertainties associated with a specific drilling operation along with a financial risk and return mapping of feasible configurations associated with a particular drill operation as well as a fleet impact. The actionable decision support relates to the type of drilling assets to configure, the configuration of those assets and their operation.

Oil reserves and the assets required to realize them take on the attributes of liability-asset management in the domain of insurance. Regarding insurance, current income must be produced while a probabilistic liability must be accounted for via investments today so as to pay off when a claim is made tomorrow. Similarly, reserves are probabilistic assets that must be explored with a portfolio of drilling assets today such that tomorrow's financial objectives are met within the operating constraints of current income requirements.

According to one embodiment, a global asset of drill rigs (leases, tenures) are allocated against reserves that are known, developing and probabilistic future finds. These reserves are valued subject to stochastic spot price scenarios using a multi-period mixed integer programming (MIP), sequential linear programming (SLP) and stochastic optimization using a real options valuation framework.

Configuring a portfolio of drilling assets is accomplished by matching reserves that are secured now and that which is probabilistically secured in the future with regional drilling assets over an adjustable planning horizon. The secured oil assets are characterized probabilistically for volume, such as by quartile while estimating the reserves not as yet identified but likely to be secured within the plan horizon. While the objective function is to maximize portfolio net present value (NPV), controlling for a selectable level of plan risk variation, a modified efficient frontier is calculated over the feasible solution set. Depending upon the degree of variance, three optimization methods are used: Linear or Mixed Integer Programming, Sequential Linear Programming and Stochastic. Beyond traditional NPV, a real option valuation is enabled whose assumptions are driven from simulation based transfer functions with path dependent capability. Thus, the allocation of assets is matched for known and probabilistic future results.

The output is a dynamic asset match and fleet right sizing for the risk/return appetite of the exploration and production entity. The actionable decision support results in a recommendation of what type of drilling assets to secure, where and when to deploy them.

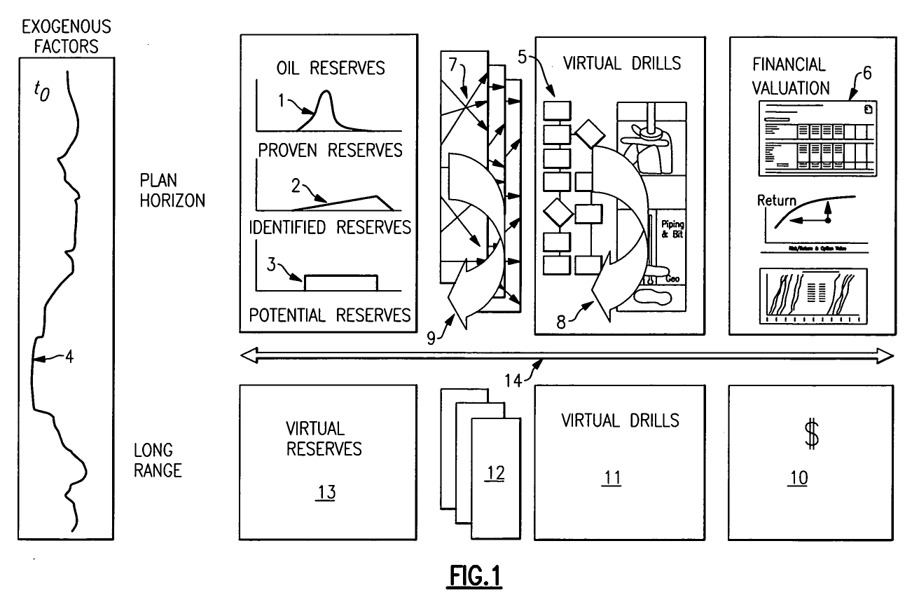

Looking now at FIG. 1, oil reserves are classified as three types for the purposes of the asset configuration: 1) proven (in terms of well understood location and available quantity), 2) identified (in terms of secured or negotiating the rights to potential reserves where the exact location and quantity of oil is not well known) and 3) potential reserves (that are likely to exist in a region, but no exploration work or specific contract rights have begun). The values describing the physical attributes of reserves are probabilistic and temporal. Production can and does start at different times. Quantity of oil is also variable. Proven reserves have a relatively high precision in terms of quality, quantity and time whereas the specifics of reserves in process of being explored have much less precision.

Exogenous forces can drive the incentives for many of the endogenous decisions related to what and how to drill. The incentive to select reserves is influenced by the present value of oil and gas rights. It is assumed that spot and crude futures price is dominated by the global petroleum market and as such is exogenous. An illustrative example of an exogenous variable is the price of oil. The exogenous path 4 is simulated as a random walk, drawing from a price increment random distribution as well as from shock scenarios. As an example of the coupling between exogenous forces and endogenous choices in a high price environment, it may make great sense to add to the portfolio, oil and gas reserves that have significant volume upside potential as opposed to those which have precise understanding and limited volume. It may also make sense to change the drill rig leasing terms and conditions or machine reliability or capacity or how hard to run the drill.

A mathematical model of the physical system is derived for simulation purposes. This object oriented ‘virtual rig’ 5 is configurable from a selection set of apparatus that includes major engineered subsystems such as the top drive, draw works, mud pumps, bottom hole assembly, drilling depth capability and crew. The virtual rig 5 has a physical location that can be moved within constraints and at the rates specified. Drilling capabilities with fixed and variable cost are characterized as a function of physical apparatus selected. Virtual drill rigs have life consumption from initial set-up and from use in the simulated world. Subsystem reliability is characterized from actual reliability analysis and estimated from historical peer or judgmental assessment when no data yet exists. Drill operating choices are made with rule engines embedded in the simulation or with intervention during the simulation by the analyst. The fleet of rigs is simulated, each conforming to its unique configuration, selected hole to drill and oil or gas reserve matrix. The fleet global constraints are adhered to where these exist (such as a limitation on the number of particular drills or drilling apparatus or staffing, refinery or transportation capacity and the like.

The financial results of moving and drilling with a virtual rig 5 are calculated as a function of time, accounting for the drilling decisions and specific oil reserve the rig is applied to, as represented in block 6 in the simulation recommendations. The ratio of net forecasted production enabled with a drilled hole over the net cost to drill to that forecasted production is calculated on a per rig basis. Results, from the aggregation of the many virtual rigs in the theoretical fleet are calculated. Total fleet production and costs are tabulated for each simulation run of each rig and fleet portfolio for each configuration of rig, hole and reserve feasible decision. Financing mechanisms, depreciation, tax, and operating costs from the virtual drilling operation simulation are used to calculate free cash flows.

While the analytical infrastructure may calculate all combinations of all rigs and all configurations of a rig to all reserves, this would be extraordinarily computationally complex and time consuming. In each of the configurations of feasible subsystem selections on rigs and in matching of rig to reserve, the abilities of mathematical programming are leveraged so as to collapse the number of simulation scenarios and their replications to those which appear to best achieve the overall system objective(s), most robustly, subject to the stochastic path of exogenous forces.

The nested loop of selection and simulation is thus:
a. Baseline emulation and simulation forward of the fleet ‘as-is’
b. Reserve to Rig assignment with transportation
c. Drill path simulation
d. Reserves quantity and quality
e. Drill rig physical system selections and replications with each replication sampling from the stochastic path of the exogenous forces when calculating financial results
f. Next assignment and transportation

Heuristic, sequential linear programming (SLP), mixed integer (MIP), integer (IP) and linear programming (LP) are used to reduce the simulation computation load for rapid exploration of the most robust solution space prior to launching explicit replication and optima or robustness seeking simulation. The assignment 7 of which rig to what oil reserve is varied amongst simulation runs. The test assignment 7 is not completely random but rather follows a closed form algorithm which eliminates the least likely multi-period probable fleet optima of total production/total cost using actual starting physical configurations and lifting from the real fleet. There can be multiple criteria sought, as is the case for portfolio management of real and financial assets.

For a given configuration (assignment 7) of oil reserve to drill rig, the virtual drilling operation is replicated as represented in step 8 until such time as the probabilities generated become characterized (the marginal utility from the next simulation is not significant; no new information is provided). The temporal range of reserves and its likely geology is generated from the assignment 7 and a drill configuration is simulated with each run providing an output to the financial valuation 6. Alternative drill configurations are also simulated until such time as each feasible configuration is replicated enough to characterize the financial ramifications of the selection.

Once the virtual fleet has run with the virtual rigs, new assignments are made between reserve and rig as represented in step 9; and then the per rig simulations 8 are replicated for the new assignments. This is replicated for all rig configurations, reserve assignments and exogenous factor variations.

The most often sought decision support relates to the best match of drilling asset to reserve and this has been discussed above. It can also be advantageous to work backwards from desired risk/return objectives subject to certain financial metrics and identify what types of assets to secure under lease or purchase or what quantity and where or even what type of reserve profile best fits the available fleet of rigs and other reserves currently in a portfolio. This forward and backward chaining capability (enumerated 14 in FIG. 1) is of high value to corporate financial planning, financing, investing and analysis, capital structure planning and business operations. Blocks 10, 11, 12 and 13 which enable the backwards chaining of ‘what-if’ scenarios or goal seeking or sensitivity analysis that would be of high utility to the stakeholders previously mentioned depict longer range planning.

In nearly all industrial system modalities from aircraft engines to power generation to locomotive to electronic systems, uptime is demanded; and inspection technologies have been created to increase the reliability of these assets. These include non-contact, remote access eddy-current, ultrasound, x-ray and thermo-graphic absorption methods. Oil pipelines, for example, are typically inspected without coupon sampling.

Inspection technologies are built to eliminate specific failure modes. The result is a portfolio of inspection technology that abates operations risk associated with apparatus reliability degradation. The actionable decision support is a quantitative risk assessment of critical path drill string systems that have been inspected for known failure modes. A specific risk weighted decision support metric is provided for drill/fix/replace and timetable. An illustrative example is a digital x-ray or contact ultrasound of the drill string with an analytical estimation of metal integrity.

Drill configuration, physical sensing, historical use and current operations dominate the causality drivers related to operational risk once the asset is selected, inspected and deemed suitable for use. The reliability of the drill string is dominated by related dynamic operations decisions. The objective of this sensor aided decision support method and system is to increase the fleet's production while lowering its total cost. Drill rate (Rate of penetration; ROP) is dependent on several factors, which are mostly down hole drilling parameters, and are typically beyond the current control of the driller. These factors include weight on bit (WOB), revolutions per minute (RPM), vibration, torque, hole condition, bit aggressiveness, depth of cut, mechanical specific energy and rock compressive strength. ROP is a factor that can be maximized only if all these factors are taken into consideration yet it is difficult to do for lack of sensing and real time analytical decision support.

A novel approach to maximizing ROP, according to one embodiment, is the use of mechanical specific energy (MSE) which provides the ability to detect real time changes in drilling efficiency by monitoring drilling parameters and recognizing optimum parameters supported by quantitative data to allow for re-design in areas as diverse as: well cleaning practices, bottom hole assembly (BHA) design, bit selection, etc.

To achieve this sensor based decision support, MSE data is integrated within a particular field (geological area) with other on-line operational parameters. A drilling analytical workbench feeding the on-line model and/or heuristic based transfer function environment is effective. The decision support engine is then used in operations to predict the onset of unwanted events and serve, as a decision tool that can be used in conjunction with other computer-based control systems in a drilling operational environment.

The output is an interactive drilling rate operations support assistant. The actionable decision support is brought to the operator who would benefit if only the risk and return of various operating decision such as ROP, WOB and RPM could be assessed given all other drilling dynamics.

The objective of the operations and drill path decision support method and system then is to increase the fleet's production while lowering its total cost. The work applied to the drill bit matters a great amount. In recovering lost time due to an exogenous factor such as weather delays or an unanticipated rock density formation, the decision to accelerate drill rate to make up time may raise the probability of equipment failure, mechanical wear-out or down hole seizure of the bit. It is unlikely that the operators are independently able to make the risk/return decisions needed to stay risk neutral on drill rate.

The leverage of simulation based real option valuation can have significant utility when aiding with the operating decisions associated with selecting the drill string apparatus, rates of feed, maintenance and in one embodiment, the drill path staging itself. Working with sensor based drilling operations algorithms, the probabilities of drill fracture and abandonment are calculated.

The strategic placement of debarkation points along the hole, proportional to the risk of drill seizure and in-situ failure are coupled with the sensing systems and real-time, dynamic option valuation financial methods being brought together.

The output is an interactive hole path operations support assistant. The actionable decision support is brought to the operator who would advantageously benefit if only the risk and return could be weighed for drilling staging to avoid abandonment of the entire or significant amounts of the hole due to a failed drill string.

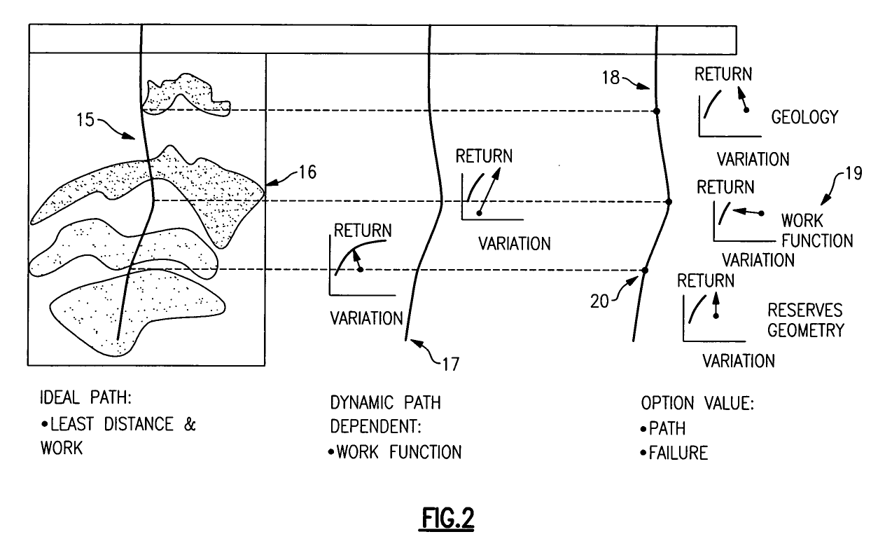

FIG. 2 depicts a methodology, according to one embodiment, that views each drill path increment as a decision point. Given the path that has been followed thus far and the likely trajectory yet to go and the geological formations in this continuum and estimations of physical reliability in the context of the asset configuration, its sub system history and current operations, and certainty of the understanding of the oil reserve geometry, the optimally rewarded rate, position and location of the next depth segment can be estimated.

Ideally a drill path 15 that is most direct and that minimizes total work on the drill string and hits a location which harvests the full reserve would be planned and sought. This would be nearly impossible to do across the fleet; yet incorporating what is being learned along the drilling operation into the next hour's operations may significantly shift the mean performance of the fleet and reduce the number of very expensive events where holes must be abandoned or re-drilled for lack of precision or undercompensated operations decisions.

Given that the objective of a sensor aided decision support method and system is to increase the fleet's production while lowering its total cost, key decisions can be supported with the accumulated analytics available. This knowledge is brought to the front line where the drill operations decisions are made.

In instances where geology 16 varies both in its physical geometry and density, it is possible to control the drilling forces and vibrations by adjusting speed and advance rate so as to maintain a constant work function at the bit and not precipitate a fatigue failure. When drill rates can be increased and they are kept constant, and the accumulated lifing wear has not approached fatigue limits, keeping a steady rate may lower the physical and financial variation, yet not capture the available economic returns from reaching oil reserves sooner.

Alternatively, a bit with accumulated work that is being consumed at a rate approaching fatigue will cross a non-linear risk boundary where the benefits of continued drilling are diminished by the increased probability of a failure that will require extensive rework or hole abandonment. The objective is to increase the probabilities across the thousands of fleet decisions that are made every hour for more favorable outcomes that are properly rewarded for a given risk and to intervene where failures would be particularly costly.

An example of a particularly costly failure is at the end of a hole 17 when a drill loss occurs and the bit must be abandoned. There was a point in time before the drill loss where exchanging apparatus or slowing rate of feed would be beneficial, despite the delays introduced, because the accumulated probabilities of failure and the requisite recovery would outweigh the opportunity cost of reaching oil at a linear projection of time.

Selected drill path and path related modifications present opportunities for value creation. One scenario is the entry point selection(s) to the eventual successful drill path. How many holes and where to explore may have the attributes of options in that an expense (premium) is realized with an exploratory hole for the attainment of added knowledge and operating flexibility. This may be especially true where geology constraints are identified during the drilling operation and paths are desired to be known that lower the total drilling cost. Key is valuing the prospective path(s) 18 as the drill operation is occurring.

Work function is a proxy for probabilistic remaining fatigue life. A drill string with accumulated hours of dense rock that is subjected to vibrations and various drill rates, some of which may have been excessive, may have a high probability of failure when the density of material increases. Incorporating decision support at the time of drilling, across a fleet of drilling operations, can impact the mean performance by reducing the incidence of catastrophic failures. When the probability of failure for the drill string as a result of its prior work plus the simulated likely work given the current readings exceeds the risk adjusted economic rate of return, the drilling operator is made aware 19, and either speed can be reduced or the down hole apparatus serviced. Key is that the decision support is on line and prescriptive for the hole as a complete process.

Creating debarkation points that allow a plurality of hole extensions reduces risk. How many holes and where in order to harvest the oil can be a function of the geometry of reserves. More precise information is gathered during drilling operations from down hole sensors. Drill string failure at the end of a hole is more costly than the same occurring at the start of an operation. Both the plurality of access and the notion of opportunity loss with an abandoned deep hole share the attributes of benefiting from a waypoint along the drill path that allows the later option to proceed to a new path from (mostly) the same hole. Decision support as to where to create such a debarkation point 20 is needed to lower the fleet cost of rework and lower the impact of down hole failures.

Simulation of the virtual drill and drilling operations and the valuation of the various design and operations choices are key enablers to shifting the mean of the drilling portfolio and reducing extreme negative event frequency. There are three components to achieving this capability, which include:
1) Reliability and Performance databases and algorithms that accurately characterize input assumptions;
2) Simulation and optimization modalities that accurately characterize asset allocation, configuration and operations across their range of probable results, not ignoring the path and causality of those results; and
3) Financial valuation methods that include traditional indicators as well as probabilistic and real option valuations tied to the actionable decisions available in asset allocation, configuration and operation.

In the examples of systems that were modeled with path dependence and exposed to exogenous variation, value was designed into the structure of the system and into the lifecycle decisioning. One can calculate the costs to engineer assorted options into the system that increase its financial utility.

According to one embodiment, simulation based transfer function(s) of the business system (including its path dependent actions and design options) are derived and exposed to the exogenous forces the system is to be robust against. The results of the simulation replications feed the assumptions of a financial pro form a and then a statistical database from which runs data can be recalled. The system parameters, exogenous factors and performance outcomes are collected.

The output of the system is typically probabilistic. The present value is one such measure that is captured from simulation driven financial valuation; and its observations are plotted on a histogram 150 such as depicted in FIG. 10 that illustrates a stochastic simulation approach applied to power turbines.

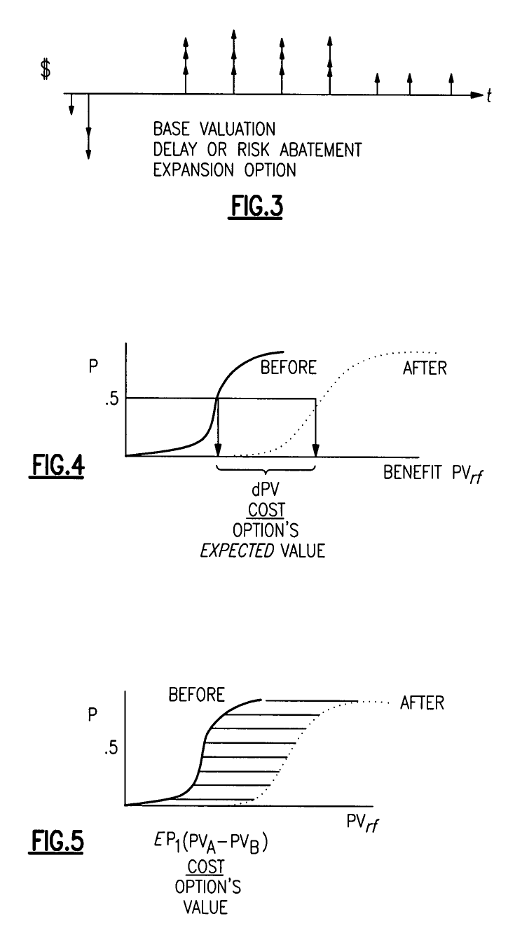

Investment can be thought of as a project baseline or a sunk cost to achieve the economic value associated with a firm's operations. In the case of oil drilling, it is assumed that there will need to be drilling operations, that is a given of being in the business. That said, there are other investments that can be made which increase the forecast precision such that eventual drilling operations yield more oil at a lower marginal cost. There may be investments such as a fee to transfer risk. In these instances, the benefits result from having incremental capabilities beyond the base case and the cost to attain the rights to these potential benefits can be thought of as options. An option gives one the right but not obligation to do something. In the same way, options can be engineered using real asset features and decisioning. An example is described below with reference to FIG. 3 that graphically illustrates base valuation, delay or risk abatement, and expansion option factors on a cost versus time basis.

Example: The base operation is a sunk cost of doing business and its costs and benefits uncertainties are captured in the discount rate of the firm's total enterprise. Other investments can be made in stages to gather more information while yet other investments can be made in features related to attaining more potential benefits; these can be ameanable to real option valuation techniques. Not all valuations of real options are standard given that they are not traded and are as unique as the physical systems and the operations choices they are designed to aid.

One method, shown in FIG. 4, used to find the value of a design feature in a system is to compare a before and after case, convert frequency to a probability density function, integrate that to form a cumulative probability distribution and calculate the expected change in value (the 50% percentile). The discount is made at the risk free rate or at least the lowest risk investment alternative for the situation, an example being a low risk alternative investment option.

This method is a robust one provided that the limits of “expected value” are respected. Single numbers such as NPV or Real Option Value are data points amongst other data points. They are good approximations; yet they too have limitations due to the compression of all notions of value into a single number absent context.

Another alternative, shown in FIG. 5, is to integrate the relative difference in present value (PV) for all probabilities by the relative weights of the corresponding probability and sum up the value.

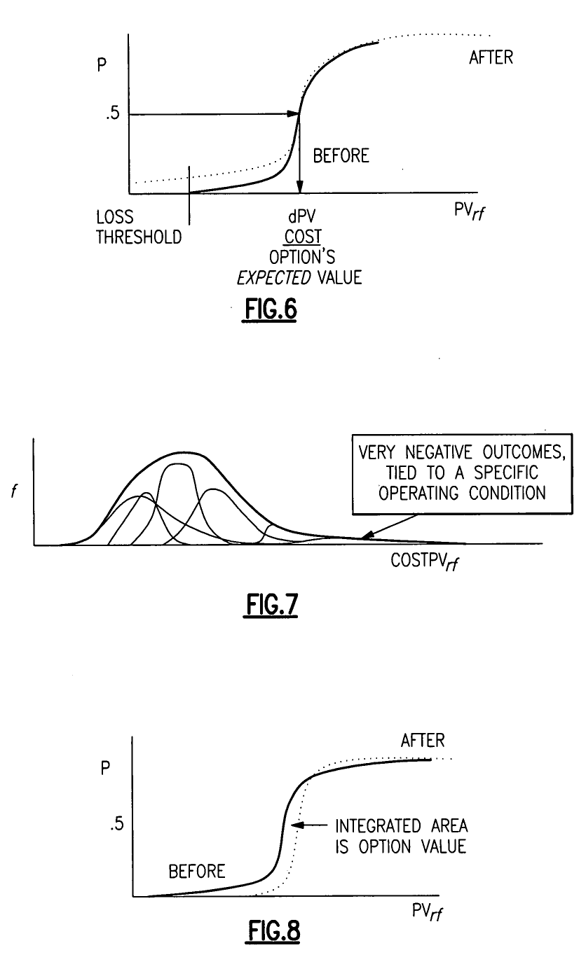

Consider now the cumulative probability distributions illustrated in FIG. 6 that depict the output of a system before and after an option is added to improve performance. The expected value remains the same, while the probability of upside value creation is very high. The probability of losing value is also increased. Yet these may not have symmetrical ramifications. Losses can be such that the investment value implodes and therefore are not acceptable.

One embodiment ties physical action and financial reaction. Thus, a possible method of calculating the expected value option is to characterize the system output as not one probabilistic distribution but instead as being the result of several. The task now becomes one of utilizing the analytical infrastructure and finding subsets of the physical system or decision domain points that create causal clusters of undesirable outcomes, and reducing the likelihood of this cluster occurring by trading off the cluster risk against the cost or benefits of that reduction.

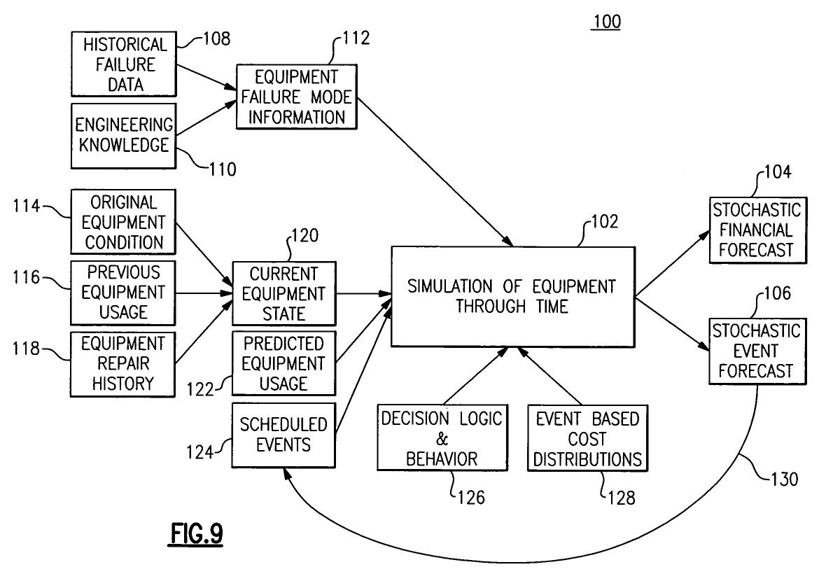

FIG. 7 is a histogram of costs related to an investment, according to one embodiment. The question is whether the aggregate distribution is the only possible set of system outputs; or is it the sum of various configurations of the system? If there are states of the system (identified through the data base of runs and configurations) that have causality that can be designed out, one can calculate the explicit value of this “pocket” of undesirable outcomes.

Viewing system level performance with a capability to assess the impacts of specific causality is a core enabler of the methods and approaches described herein. The system produces the behaviors observed; and therefore, to intervene into the system, the focus according to one embodiment, is upon identifying and modeling the dynamic transfer functions that create observed behavior. Understanding the structure of the system is an analytical challenge. With a certain systemic attribute designed out by physical configuration or path dependent asset decisioning, a favorable change occurs to the probabilistic system level output. The net of benefit less cost (premium) to attain that probabilistic future benefit is the option value. The option has value when the exogenous forces and operations are such that the intervention, because it was made, has utility.

A single number for NPV or Option Value is typically avoided because one is more interested in the context of risk and return to achieve robustness. That said, the business world is parsimonious and wants ‘a number’. To calculate that number for option value, the area is integrated under the NPV cumulative probability distribution, such as illustrated for one embodiment in FIG. 8.

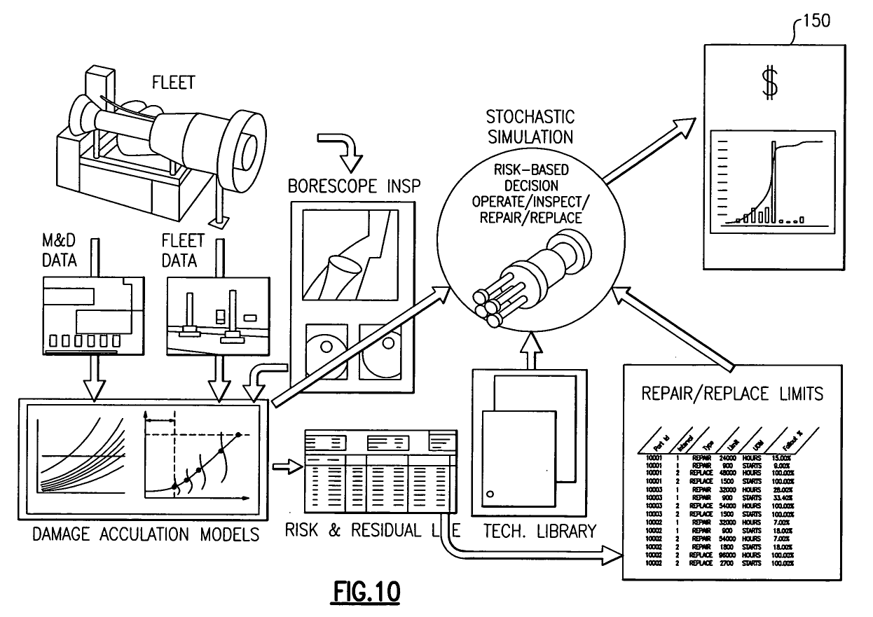

Keeping the foregoing principles in mind, FIG. 9 is a block diagram illustrating an interactive decision-support planning tool 100 according to one embodiment. Interactive decision-support planning tool 100 aids a user as to how to select a portfolio of engineered systems and entities that the systems will process such as aircraft engines and flights, rigs and reserves, apparatus configuration, apparatus inspection, apparatus on line sensors, dynamic operations decisioning for the apparatus and drill path or asset dispatching and a contractual incentive to allocate risks to stakeholders best positioned to abate them. The decision support will reduce a fleet's financial risk associated with the cost of operations below that achievable without using the interactive decision-support planning tool and/or increase financial return associated with the cost of activity above that achievable without using the interactive decision-support planning tool, such that the financial risk and/or financial return are allocated in a desired manner among a plurality of operations stakeholders.

Interactive decision-support planning tool 100 aids a user as to how to, for example, drill a well and how to make drilling decisions while the well is being drilled. The interactive decision-support planning tool 100, when used for example in association with well drilling decisions, is then operated to generate drilling decisions that reduce financial risk associated with the cost of drilling the well below that achievable without using the interactive decision-support planning tool and/or increase financial return associated with the cost of drilling the well above that achievable without using the interactive decision-support planning tool, such that the financial risk and/or financial return are allocated in a desired manner among a plurality of drilling operation stakeholders, wherein the stakeholders are held contracturally to subsets of the fleet of asset's risks.

With continued reference now to FIG. 9, the interactive decision-support planning tool 100 includes a simulator 102 that functions to perform a desired number of simulations of one or more physical well drilling systems. The simulator 102 generates a stochastic financial forecast 104 and a stochastic event forecast 106 in response to a plurality of input data.

The input data includes, but is not limited to, historical failure data 108 and prior engineering knowledge 110 that is processed to generate equipment failure mode information 112 that provides one type of information that can be utilized by the interactive decision-support planning tool 100 to generate the stochastic financial forecast 104 and the stochastic event forecast 106.

The input data also includes original equipment condition data 114, previous equipment usage data 116, and equipment repair history data 118 that together are processed to provide the current state of equipment data 120 for use by the interactive decision-support planning tool 100 to generate the stochastic financial forecast 104 and the stochastic event forecast 106. Much of this data can be modified continuously or intermittently via one or more predetermined sensors that operate in a desired fashion and that are integrated according to one embodiment, into the current equipment state element 120.

Other input data can be seen to include, for example, predicted equipment usage data 122, scheduled event data 124, decision logic and behavioral data 126, and event based cost distribution data 128. Scheduled events data 124 may be modified after a simulation run via a feedback loop 130 if an undesired random event is triggered by the stochastic event forecast 106. A stochastic event forecast 106 may reveal, for example, a significant number of equipment failures during a certain period of time. This information can then be used via feedback loop 130 to modify a scheduled event 124 such as, but not limited to, a shop visit for repair and/or maintenance.

The decision logic and behavioral data 126 may include information including, but not limited to, work scoping and shop behavior, i.e. what type(s) of repairs and/or maintenance are being employed, the duration of the repair and/or maintenance process, and inventory management processes such as equipment replacement decisions.

Event based cost distribution data 128 relate to, among other things, costs associated with particular internal and/or external, ie. customer based decisions. These may include, for example, the cost of replacing a particular failed or worn part with a new part. Event based cost distribution data 128 in some instances may be fixed numbers; while in other instances, will be number distributions.

A stochastic event forecast 106 is employed to consider events that can occur in a random fashion, but are not generally planned for in advance such as, but not limited to, an Act of God castrophe that may cause an equipment failure. Such random events can be very costly and may require, for example, scheduling an additional shop repair.

As stated herein before, the interactive decision-support planning tool 100 ensures that an asset including in one embodiment, a drill string, geology and reserve, is configured that matches the reliability and performance of apparatus to an explicit drilling application so as to maximize the probability, in the context of a portfolio of drilling operations, specific assets to probabilistic reserves and paths to reserves.

A specific drill configuration is attained with the interactive decision-support planning (simulation based design) tool 100 that explores all desired combinations of available and feasible drill platforms. The ‘virtual drill’ which is a model of the selected physical assets draws assumptions from a reliability and performance database that is then utilized to simulate a portfolio of drilling operations to generate a stochastic financial forecast 104.

The interactive decision-support planning tool 100 including simulator 102 thus allows movement of equipment and decisions, e.g. well portfolio, drill rig portfolio, drill apparatus, apparatus inspection, apparatus on line sensors, dynamic operations decisioning for the apparatus and drill path and contractual incentives, through time under given or stochastic operating conditions. The simulation produces stochastic forecasts for expected costs (e.g. repair costs, part costs) and for expected events (e.g. repair events).

The current equipment state 120 is used as a starting point in order to create a realistic output. The current equipment state is determined based on the original equipment condition (e.g. delivery date and exactly what parts were employed in the drill rig portfolio), previous equipment usage (e.g. operating hours and cycles over time for apparatus on line sensors) and repair history (e.g. which parts have been repaired/replaced and when).

Other required inputs, as stated herein before, are the predicted equipment usage 122 over the time period simulated, and scheduled events 124 (e.g. scheduled shop visits or inspections).

For each piece or sub-piece of equipment, failure mode information 112 (possible modes of failure and the corresponding stochastic distributions) is used in the simulation to simulate equipment failures.

Repair logic, shop turn-around times, cost distributions 128 and other behavior or decision logic 126 can also be applied.

One interactive decision-support planning tool has been applied successfully by General Electric Aviation to allow movement of equipment, e.g. aircraft engines through time under given or stochastic operating conditions and produce stochastic forecasts for expected costs there from. Further, stochastic shop visit forecasts have been used successfully to modify the scheduled events, i.e. to schedule shop visits for some aircraft engines early in order to balance the workload for the service shops.

The foregoing interactive decision-support planning tool 100 allows consideration of what-if scenarios to study the financial impact and the impact of forecasted events, e.g. the impact of changing the inspection scheduling logic. Another option is to study the impact of increased life on individual parts or reduction of costs at any point. In general, one can study the impact of variations or changes on any of the assumptions described above using the interactive decision-support planning tool 100 as described in further detail herein below.

More specifically, the decision-support planning tool 100 can operate to determine the financial risk and/or return in configurable time segments associated with a plurality of physical well drilling systems using a simulation based approach comprised of inter-operable model objects and taxonomy that comprise at least one of a physical system object, a financial object and an exogenous assumption object, such as described herein before.

The decision-support planning tool 100 can also operate to integrate multiple modeling, factoring between exogenous and endogenous variation and decision elements for the calculation of optionality, risk and/or return related to the cost and benefit of configuring and drilling the well.

The decision-support planning tool 100 can also operate to determine a financial risk and/or return that is based on selection of relevant objects for simulation of a well drilling configuration in the presence of exogenous variation.

The decision-support planning tool 100 can also operate to determine a financial risk that is based on calculation of probabilities of a change in risk for an operating configuration in the presence of exogenous assumption variation.

The decision-support planning tool 100 can also operate to determine a financial return that is based on calculation of probabilities of a change in return for an operating configuration in the presence of exogenous assumption variation.

The decision-support planning tool 100 can also operate to determine a relationship between risk and return for a configurable time segment in the presence of exogenous assumption variation for a physical system configuration or for an operations decision or for a change in a physical or financial state of the well drilling method.

The decision-support planning tool 100 can also operate to determine a value change in the presence of exogenous assumption variation for a physical well drilling system configuration, an operations decision or change in the state of the physical well drilling system or financial constraints as a decision support tool during establishment of contract terms, pricing, renewal, termination or intra contract period adjustments.

The decision-support planning tool 100 can also operate to determine a path dependent value or risk change for a configuration or operating decision.

The decision-support planning tool 100 can also operate to aid optimization, scheduling, dispatch, terms, operating parameters and pricing to effect financial and/or operational metrics related to a physical well drilling system or financial constraints.

The decision-support planning tool 100 can also operate to utilize a change in risk and/or return at a point of operations decisioning in order to improve local and/or global probabilities of higher economic value creation relative to the probability of a shortfall or violation of a constraint.

The decision-support planning tool 100 can also operate to integrate analytical transfer functions with a publish and subscribe messaging architecture having a structured taxonomy for the calculation of risk and/or return related to physical or financial systems.

The decision-support planning tool 100 can also operate to analyze real world and simulated data by the storage of actual operating parameters, results and values whether generated in actual physical operations or simulation where these values are captured and recorded as integral to objects being simulated or captured and recorded in a separate database designed to capture longitudinal values.

The decision-support planning tool 100 can also operate to record the consumption of parts, parts life, operating parameters, state of the system, exogenous forces, costs and taken or anticipated decisions for the purposes of analytical simulations to calculate what-if scenario risk and return in oil well drilling apparatus.

The decision-support planning tool 100 can also operate to provide automated analytical workflow to clean, configure and call requisite data, populate and call the requisite transfer functions and post process results for dynamically configurable presentation.

The decision-support planning tool 100 can also operate to shift and/or measure a financial risk and/or return associated with a cost of drilling the well, to a desired business entity.

The decision-support planning tool 100 can also operate to provide a systematic approach that raises the mean productivity of fleet drilling apparatus by improving the likelihood of differentially more value creation than risk across a plurality of discrete decisions in asset matching, drilling selection, setup and operation, while also reducing the frequency of very costly field failures far down a well hole.

The decision-support planning tool 100 can operate in response to, and without limitation, historical life data, inspection life assessment and simulated forward duty forward and/or actual sensor readings to calculate drill speed, weight on bit, drill path, and drill path route via one or more intermediate branch points.

The decision-support planning tool 100 can also operate to provide a fleet portfolio rationalization process to match what rig configuration on which rig to what reserve, in temporal progression.

In summary explanation, an industrial risk transfer system and method have been applied to well planning and construction, aircraft engines, power turbines, locomotives, diagnostic imaging equipment, among others, to provide substantial performance optimization opportunities. The industrial risk transfer system and method challenges existing industry paradigms, offering an operator improved value incentives through well portfolio selection, drill rig portfolio selection, drill apparatus configuration, apparatus inspection, apparatus on line sensors, dynamic operations decisioning for the apparatus and drill path and a contractual incentive to allocate risks to stakeholders best positioned to abate them, optimized authorized funds for expenditure (AFE) preparation, well risk identification, mitigation and potential outcome decisioning, as well as quantification of risk/reward in consideration of new drilling technology adoption.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of drilling a well, the method comprising:
providing an interactive decision-support planning tool that aids a user as to how to drill the well and how to make drilling decisions while the well is being drilled; and
operating the decision-support planning tool to generate drilling decisions that reduce financial risk associated with the cost of drilling the well below that achievable without using the interactive decision-support planning tool and/or increase financial return associated with the cost of drilling the well above that achievable without using the interactive decision-support planning tool, such that the financial risk and/or financial return are allocated in a desired manner among a plurality of drilling operation stakeholders, wherein the stakeholders are held contracturally to subsets of the fleet of asset's risks.

2. The method according to claim 1, further comprising operating the decision-support planning tool to determine the financial risk and/or return in configurable time segments associated with a plurality of physical well drilling systems using a simulation based approach comprised of inter-operable model objects and taxonomy that comprise at least one of a physical system object, a financial object and an exogenous assumption object.

3. The method according to claim 1, further comprising operating the decision-support planning tool to integrate multiple modeling, factoring between exogenous and endogenous variation and decision elements for the calculation of optionality, risk and/or return related to the cost and benefit of configuring and drilling the well.

4. The method according to claim 1, further comprising operating the decision-support planning tool such that the financial risk and/or return is based on selection of relevant objects for simulation of a well drilling configuration in the presence of exogenous variation.

5. The method according to claim 1, further comprising operating the decision-support planning tool such that the financial risk is based on calculation of probabilities of a change in risk for an operating configuration in the presence of exogenous assumption variation.

6. The method according to claim 1, further comprising operating the decision-support planning tool such that the financial return is based on calculation of probabilities of a change in return for an operating configuration in the presence of exogenous assumption variation.

7. The method according to claim 1, further comprising calculating a relationship between risk and return for a configurable time segment in the presence of exogenous assumption variation for a physical system configuration.

8. The method according to claim 1, further comprising calculating a relationship between risk and return for a configurable time segment in the presence of exogenous assumption variation for an operations decision.

9. The method according to claim 1, further comprising calculating a relationship between risk and return for a configurable time segment in the presence of exogenous assumption variation for a change in a physical or financial state of the well drilling method.

10. The method according to claim 1, further comprising calculating a value change in the presence of exogenous assumption variation for a physical well drilling system configuration, an operations decision or change in the state of the physical well drilling system or financial constraints as a decision support tool during establishment of contract terms, pricing, renewal, termination or intra contract period adjustments.

11. The method according to claim 1, further comprising operating the decision-support planning tool to calculate a path dependent value or risk change for a configuration or operating decision.

12. The method according to claim 1, further comprising operating the decision-support planning tool to aid optimization, scheduling, dispatch, terms, operating parameters and pricing to effect financial and/or operational metrics related to a physical well drilling system or financial constraints.

13. The method according to claim 1, further comprising operating the decision-support planning tool to utilize a change in risk and/or return at a point of operations decisioning in order to improve local and/or global probabilities of higher economic value creation relative to the probability of a shortfall or violation of a constraint.

14. The method according to claim 1, further comprising operating the decision-support planning tool to integrate analytical transfer functions with a publish and subscribe messaging architecture having a structured taxonomy for the calculation of risk and/or return related to physical or financial systems.

15. The method according to claim 1, further comprising operating the decision-support planning tool to analyze real world and simulated data by the storage of actual operating parameters, results and values whether generated in actual physical operations or simulation where these values are captured and recorded as integral to objects being simulated.

16. The method according to claim 1, further comprising operating the decision-support planning tool to analyze real world and simulated data by the storage of actual operating parameters, results and values whether generated in actual physical operations or simulation where these values are captured and recorded in a separate database designed to capture longitudinal values.

17. The method according to claim 1, further comprising operating the decision-support planning tool to record the consumption of parts, parts life, operating parameters, state of the system, exogenous forces, costs and taken or anticipated decisions for the purposes of analytical simulations to calculate what-if scenario risk and return in oil well drilling apparatus.

18. The method according to claim 1, further comprising operating the decision-support planning tool to provide automated analytical workflow to clean, configure and call requisite data, populate and call the requisite transfer functions and post process results for dynamically configurable presentation.

19. The method according to claim 1, further comprising operating the decision-support planning tool to shift and/or measure a financial risk and/or return associated with a cost of drilling the well, to a desired business entity.

20. The method according to claim 1, further comprising operating the decision-support planning tool to provide a systematic approach that raises the mean productivity of fleet drilling apparatus by improving the likelihood of differentially more value creation than risk across a plurality of discrete decisions in asset matching, drilling selection, setup and operation, while also reducing the frequency of very costly field failures far down a well hole.

21. The method according to claim 1, wherein the interactive decision-support planning tool is configured to be responsive to historical life data, inspection life assessment and simulated forward duty forward and/or actual sensor readings to calculate drill speed, weight on bit, drill path, and drill path route intermediate branch point via the interactive decision-support planning tool.

22. The method according to claim 1, wherein providing an interactive decision-support planning tool that aids a user as to how to drill the well and how to make drilling decisions while the well is being drilled comprises providing a fleet portfolio rationalization process to match what rig configuration on which rig to what reserve, in temporal progression.

23. A system for drilling a well, the system comprising:
an interactive decision-support planning tool that aids a user as to how to drill the well and how to make drilling decisions while the well is being drilled; and
a plurality of sensors operational to generate data used by the interactive decision-support planning tool to reduce financial risk associated with the cost of drilling the well below that achievable without using the interactive decision-support planning tool and/or increase financial return associated with the cost of drilling the well above that achievable without using the interactive decision-support planning tool, such that the financial risk and/or financial return are allocated in a desired manner among a plurality of drilling operation stakeholders, wherein the stakeholders are held contracturally to subsets of a fleet of asset's risks.

24. The system according to claim 23, wherein the financial risk and/or return is based upon configurable time segments associated with a plurality of physical well drilling systems using a simulation based approach comprised of inter-operable model objects and taxonomy that comprise at least one of a physical system object, a financial object and an exogenous assumption object.

25. The system according to claim 23, wherein the interactive decision-support planning tool is configured to aid the user via integrating multiple modeling modalities between exogenous and endogenous elements for the calculation of the risk and/or return related to the cost of drilling the well.

26. The system according to claim 23, wherein the financial risk and/or return is based upon selection of relevant objects for simulation of a well drilling configuration in the presence of exogenous variation.

27. The system according to claim 23, wherein the financial risk is based on calculation of probabilities of a change in risk for an operating configuration in the presence of exogenous assumption variation.

28. The system according to claim 23, wherein the financial return is based on calculation of probabilities of a change in return for an operating configuration in the presence of exogenous assumption variation.

29. The system according to claim 23, wherein the interactive decision-support planning tool is configured to calculate a relationship between risk and return for a configurable time segment in the presence of exogenous assumption variation for a physical system configuration.

30. The system according to claim 23, wherein the interactive decision-support planning tool is configured to calculate a relationship between risk and return for a configurable time segment in the presence of exogenous assumption variation for an operations decision.

31. The system according to claim 23, wherein the interactive decision-support planning tool is configured to calculate a relationship between risk and return for a configurable time segment in the presence of exogenous assumption variation for a change in a physical or financial state of the well drilling method.

32. The system according to claim 23, wherein the interactive decision-support planning tool is configured to calculate a value change in the presence of exogenous assumption variation for a physical well drilling system configuration, an operations decision or change in the state of the physical well drilling system or financial constraints as a decision support tool during establishment of contract terms, pricing, renewal, termination or intra contract period adjustments.

33. The system according to claim 23, wherein the interactive decision-support planning tool functions to calculate a path dependent value or risk change for a configuration or operating decision.

34. The system according to claim 23, wherein the interactive decision-support planning tool is configured to aid optimization, scheduling, dispatch, terms, operating parameters and pricing to affect financial and/or operational metrics related to a physical well drilling system or financial constraints.

35. The system according to claim 23, wherein the interactive decision-support planning tool is configured to utilize a change in risk and/or return at a point of operations decisioning in order to improve local and/or global probabilities of higher economic value creation relative to the probability of a shortfall or violation of a constraint.

36. The system according to claim 23, wherein the interactive decision-support planning tool is configured to integrate a plurality of analytical transfer functions with a publish and subscribe messaging architecture having a structured taxonomy for the calculation of risk and/or return related to physical or financial systems.

37. The system according to claim 23, wherein the interactive decision-support planning tool is configured to analyze real world and simulated data by the storage of actual operating parameters, results and values whether generated in actual physical operations or simulation where these values are captured and recorded as integral to objects being simulated.

38. The system according to claim 23, wherein the interactive decision-support planning tool is configured to analyze real world and simulated data by the storage of actual operating parameters, results and values whether generated in actual physical operations or simulation where these values are captured and recorded in a separate database designed to capture longitudinal values.

39. The system according to claim 23, wherein the interactive decision-support planning tool is configured to record the consumption of parts, parts life, operating parameters, state of the system, exogenous forces, costs and taken or anticipated decisions for the purposes of analytical simulations to calculate what-if scenario risk and return in oil well drilling apparatus.

40. The system according to claim 23, wherein the interactive decision-support planning tool is configured to provide automated analytical workflow to clean, configure and call requisite data, populate and call the requisite transfer functions and post process results for dynamically configurable presentation.

41. The system according to claim 23, wherein the interactive decision-support planning tool is configured to shift a financial risk and/or return associated with a cost of drilling the well, to a desired business entity.

42. The system according to claim 23, wherein the interactive decision-support planning tool is configured to provide a systematic approach that raises the mean productivity of fleet drilling apparatus by improving the likelihood of differentially more value creation than risk across a plurality of discrete decisions in drilling selection, setup and operation, while also reducing the frequency of very costly field failures far down a well hole.

43. The system according to claim 23, wherein the plurality of sensors are configured to generate signals selected from weight on bit, revolutions per minute, vibration, torque, hole condition, bit aggressiveness, depth of cut, mechanical specific energy, and rock compressive strength signals.

44. The system according to claim 23, where the interactive decision-support planning tool comprises transfer functions related to configuration, selection and operations that are deployed to find the robust coverage of oil assets with available fleet using fleet risk and return in the objective function in configurable accounting periods.

45. A system for drilling a well, the system comprising an interactive decision-support planning tool that aids a user as to how to drill the well and how to make drilling decisions while the well is being drilled, wherein the interactive decision-support planning tool is configured to simulate usage of well drilling equipment and resources through time to support allocation of financial risk and/or financial return in a desired manner among a plurality of drilling operation stakeholders in response to desired input information, wherein the stakeholders are held contracturally to subsets of a fleet of asset's risks.

46. The system according to claim 45, wherein the desired input information is selected from equipment failure mode information, current equipment state information, predicted equipment usage information, scheduled event information, decision logic and behavior information, and event based cost distributions information.

47. The system according to claim 46, wherein the equipment failure mode information is based on historical failure data and engineering knowledge.

48. The system according to claim 46, wherein the equipment current state information is based on original equipment condition data, previous equipment usage data, and equipment repair history data.

49. The system according to claim 46, wherein the current equipment state information is based on equipment sensor data.

50. The system according to claim 45, wherein the interactive decision-support planning tool is further configured to generate stochastic financial forecast data in response to the desired input information.

51. The system according to claim 45, wherein the interactive decision-support planning tool is configured is further configured to generate stochastic event forecast data in response to the desired input information.

52. A method of operating an industrial engineered system, the method comprising:
providing an interactive decision-support planning tool that aids a user as to how to operate an industrial engineered system and how to make system decisions while the system is operational; and
operating the interactive decision-support planning tool to generate operational decisions that reduce financial risk associated with the cost of operating the system below that achievable without using the interactive decision-support planning tool and/or increase financial return associated with the cost of operating the system above that achievable without using the interactive decision-support planning tool, such that the financial risk and/or financial return are allocated in a desired manner among a plurality of industrial engineered system operation stakeholders, wherein the stakeholders are held contracturally to subsets of a fleet of asset's risks.

53. The method according to claim 52, further comprising operating the decision-support planning tool to determine the financial risk and/or return in configurable time segments associated with a plurality of system assets using a simulation based approach comprised of inter-operable model objects and taxonomy that comprise at least one of a physical system object, a financial object and an exogenous assumption object.

54. The method according to claim 52, further comprising operating the decision-support planning tool to integrate multiple modeling, factoring between exogenous and endogenous variation and decision elements for the calculation of optionality, risk and/or return related to the cost and benefit of configuring and operating the industrial engineered system.

55. The method according to claim 52, further comprising operating the decision-support planning tool such that the financial risk and/or return is based on selection of relevant objects for simulation of an industrial engineered system configuration in the presence of exogenous variation.

56. The method according to claim 52, further comprising operating the decision-support planning tool such that the financial risk is based on calculation of probabilities of a change in risk for an operating configuration in the presence of exogenous assumption variation.

57. The method according to claim 52, further comprising operating the decision-support planning tool such that the financial return is based on calculation of probabilities of a change in return for an operating configuration in the presence of exogenous assumption variation.

58. The method according to claim 52, further comprising calculating a relationship between risk and return for a configurable time segment in the presence of exogenous assumption variation for a physical system configuration.

59. The method according to claim 52, further comprising calculating a relationship between risk and return for a configurable time segment in the presence of exogenous assumption variation for an operations decision.

60. The method according to claim 52, further comprising calculating a relationship between risk and return for a configurable time segment in the presence of exogenous assumption variation for a change in a physical or financial state of the industrial engineered system.

61. The method according to claim 52, further comprising calculating a value change in the presence of exogenous assumption variation for a physical system configuration, an operations decision or change in the state of the physical system or financial constraints as a decision support tool during establishment of contract terms, pricing, renewal, termination or intra contract period adjustments.

62. The method according to claim 52, further comprising operating the decision-support planning tool to calculate a path dependent value or risk change for a configuration or operating decision.

63. The method according to claim 52, further comprising operating the decision-support planning tool to aid optimization, scheduling, dispatch, terms, operating parameters and pricing to effect financial and/or operational metrics related to a physical industrial engineered system or financial constraints.

64. The method according to claim 52, further comprising operating the decision-support planning tool to utilize a change in risk and/or return at a point of operations decisioning in order to improve local and/or global probabilities of higher economic value creation relative to the probability of a shortfall or violation of a constraint.

65. The method according to claim 52, further comprising operating the decision-support planning tool to integrate analytical transfer functions with a publish and subscribe messaging architecture having a structured taxonomy for the calculation of risk and/or return related to physical or financial systems.

66. The method according to claim 52, further comprising operating the decision-support planning tool to analyze real world and simulated data by the storage of actual operating parameters, results and values whether generated in actual physical operations or simulation where these values are captured and recorded as integral to objects being simulated.

67. The method according to claim 52, further comprising operating the decision-support planning tool to analyze real world and simulated data by the storage of actual operating parameters, results and values whether generated in actual physical operations or simulation where these values are captured and recorded in a separate database designed to capture longitudinal values.

68. The method according to claim 52, further comprising operating the decision-support planning tool to record the consumption of parts, parts life, operating parameters, state of the system, exogenous forces, costs and taken or anticipated decisions for the purposes of analytical simulations to calculate what-if scenario risk and return in industrial engineered system apparatus.

69. The method according to claim 52, further comprising operating the decision-support planning tool to provide automated analytical workflow to clean, configure and call requisite data, populate and call the requisite transfer functions and post process results for dynamically configurable presentation.

70. The method according to claim 52, further comprising operating the decision-support planning tool to shift and/or measure a financial risk and/or return associated with a cost of operating the industrial engineered system, to a desired business entity.

71. The method according to claim 52, further comprising operating the decision-support planning tool to provide a systematic approach that raises the mean productivity of fleet system apparatus by improving the likelihood of differentially more value creation than risk across a plurality of discrete decisions in asset matching, selection, setup and operation, while also reducing the frequency of undesired very costly field failures.

72. The method according to claim 52, wherein the interactive decision-support planning tool is configured to operate in response to equipment failure mode information, current equipment state information, predicted equipment usage information, scheduled event information, decision logic and behavior information, and event based cost distributions information.

73. The method according to claim 52, wherein providing an interactive decision-support planning tool that aids a user as to how to operate an industrial engineered system and how to make industrial engineered system decisions while the system is being operated comprises providing a fleet portfolio rationalization process to match what system asset configuration on which asset to what asset reserve, in temporal progression.

74. The method according to claim 52, wherein providing an interactive decision-support planning tool that aids a user as to how to operate an industrial engineered system and how to make industrial engineered system decisions while the system is being operated comprises providing an interactive decision-support planning tool that aids a user as to how to drill a well and how to make drilling decisions while the well is being drilled, wherein the interactive decision-support planning tool is configured to simulate usage of well drilling equipment and resources through time to support allocation of financial risk and/or financial return in a desired manner among a plurality of drilling operation stakeholders in response to desired input information, wherein the stakeholders are held contracturally to subsets of a fleet of asset's risks.
